(19) United States
(12) Patent Application Publication
(10) Pub. No.: US 2026/0241916 A1
(43) Pub. Date: Aug. 20, 2026

(54) INFORMATION PROCESSING DEVICE AND STORAGE MEDIUM

(71) Applicant: TOYOTA JIDOSHA KABUSHIKI KAISHA, Toyota-shi (JP)

(72) Inventors: Yuya AOKI, Miyoshi-shi (JP); Yohei AGATSUMA, Nagoya-shi (JP); Taku HARADA, Nissin-shi (JP); Manabu UEHARA, Miyoshi-shi (JP)

(73) Assignee: TOYOTA JIDOSHA KABUSHIKI KAISHA, Toyota-shi (JP)

(21) Appl. No.: 19/453,382

(22) Filed: Jan. 20, 2026

(30) Foreign Application Priority Data
Feb. 14, 2025 (JP) 2025-022712

(51) Int. Cl. B60W 20/13; B60W 10/06; B60W 10/26; B60W 40/12; H01M 10/44; H01M 10/48

(52) U.S. Cl. CPC B60W 20/13; B60W 10/06; B60W 10/26; B60W 40/12; H01M 10/443; H01M 10/486; B60W 2510/244; B60W 2510/246; B60W 2710/06; B60W 2710/244; H01M 2220/20

(57) ABSTRACT

An information processing device is an information processing device mounted in a vehicle including a battery and an internal combustion engine, the information processing device including: a controller configured to execute, during electric power supply from the battery to an outside: acquiring a current battery temperature of the vehicle from a sensor; determining a reference value of a state of charge for starting charging of the battery by driving of the internal combustion engine in accordance with the acquired current battery temperature; acquiring a current state of charge of the vehicle; determining whether to start the charging of the battery in accordance with the acquired current state of charge being smaller than the determined reference value; and starting the charging of the battery by driving the internal combustion engine of the vehicle when it is determined to start the charging.

### CROSS-REFERENCE TO RELATED APPLICATION

This application claims priority to Japanese Patent Application No. 2025-022712 filed on Feb. 14, 2025. The disclosure of the above-identified application, including the specification, drawings, and claims, is incorporated by reference herein in its entirety.

### BACKGROUND

### 1. Technical Field

The present disclosure relates to an information processing device and a storage medium.

### 2. Description of Related Art

Japanese Unexamined Patent Application Publication No. 2019-162896 (JP 2019-162896 A) proposes a control device that can maintain electric power supply efficiency even in a state in which a discharge performance of a power storage device deteriorates, in a hybrid electric vehicle.

### SUMMARY

An object of the present disclosure is to provide a technology that ensures an electric power supply performance and that continues electric power supply even when a battery temperature is in a low-temperature state.

An information processing device according to a first aspect of the present disclosure is an information processing device mounted in a vehicle including a battery and an internal combustion engine, the information processing device including:
a controller configured to execute,
during electric power supply from the battery to an outside:
acquiring a current battery temperature of the vehicle from a sensor;
determining, in accordance with the acquired current battery temperature, a reference value of a state of charge at which charging of the battery by driving the internal combustion engine is started;
acquiring a current state of charge of the vehicle;
determining whether to start the charging of the battery in accordance with the acquired current state of charge being lower than the determined reference value; and
starting the charging of the battery by driving the internal combustion engine of the vehicle when determination is made to start the charging,
in which the determining the reference value includes setting the reference value to a higher value as the current battery temperature is lower.

According to the present disclosure, it is possible to ensure the electric power supply performance and continue the electric power supply even when the battery temperature is in the low-temperature state.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows an example of a scene to which the present disclosure is applied;

FIG. 2 schematically shows an example of a power transmission system and an electric power supply system of the vehicle according to the present disclosure;

FIG. 3 schematically shows an example of a scene in which the reference value is determined from the battery temperature;

FIG. 4 schematically shows an example of a hardware configuration of the information processing device according to the present disclosure;

FIG. 5 shows an example of a processing procedure of the information processing device according to the present disclosure for determining the reference value of the state of charge for starting charging of the battery from the battery temperature; and

FIG. 6 shows an example of a processing procedure of the information processing device according to the present disclosure during electric power supply from the vehicle to the outside.

### DETAILED DESCRIPTION OF EMBODIMENTS

For example, in a system in the related art, such as that disclosed in JP 2019-162896 A, when the state of charge is smaller than a predetermined value during electric power supply from the vehicle to an external device, the engine is driven to charge the battery. After the charging is started, the system stops the engine in accordance with the state of charge exceeding the predetermined value. As a result, the system can maintain the electric power supply output by intermittently driving the engine to charge the battery during electric power supply from the vehicle to the external device. However, in the system in the related art, in some cases, it is not possible to ensure a sufficient electric power supply output depending on the battery temperature. That is, when the battery temperature is decreased, the electric power supply performance deteriorates, and the electric power supply may be stopped even when the state of charge does not fall below the predetermined value.

On the other hand, the information processing device according to the first aspect of the present disclosure is the information processing device mounted in a vehicle including a battery and an internal combustion engine, the information processing device including:
a controller configured to execute, during electric power supply from the battery to an outside:
acquiring a current battery temperature of the vehicle from a sensor;
determining a reference value of a state of charge for starting charging of the battery by driving the internal combustion engine in accordance with the acquired current battery temperature;
acquiring a current state of charge of the vehicle;
determining whether to start charging of the battery in accordance with the acquired current state of charge being smaller than the determined reference value; and
starting charging of the battery by driving the internal combustion engine of the vehicle when it is determined to start charging,
in which determining the reference value is configured by setting the reference value to a higher value as the current battery temperature is lower.

In this configuration, when the battery temperature is low, a timing of starting charging of the battery can be advanced. As a result, it is possible to reduce a possibility that a situation in which the electric power supply is stopped occurs even when there is a margin in the state of charge. Therefore, with this configuration, it is expected that the electric power supply performance can be ensured and the electric power supply can be continued even when the battery temperature is low.

As another form of the information processing device according to the aspect, one aspect of the present disclosure may be an information processing method of realizing all or some of the above-described components. One aspect of the present disclosure may be a program of realizing all or some of the above-described components, or a storage medium in which such a program is stored and which is readable by a machine such as a computer. The storage medium readable by a machine such as a computer is a medium that stores information such as a program by an electric, magnetic, optical, mechanical, or chemical action.

### 1 Application Example

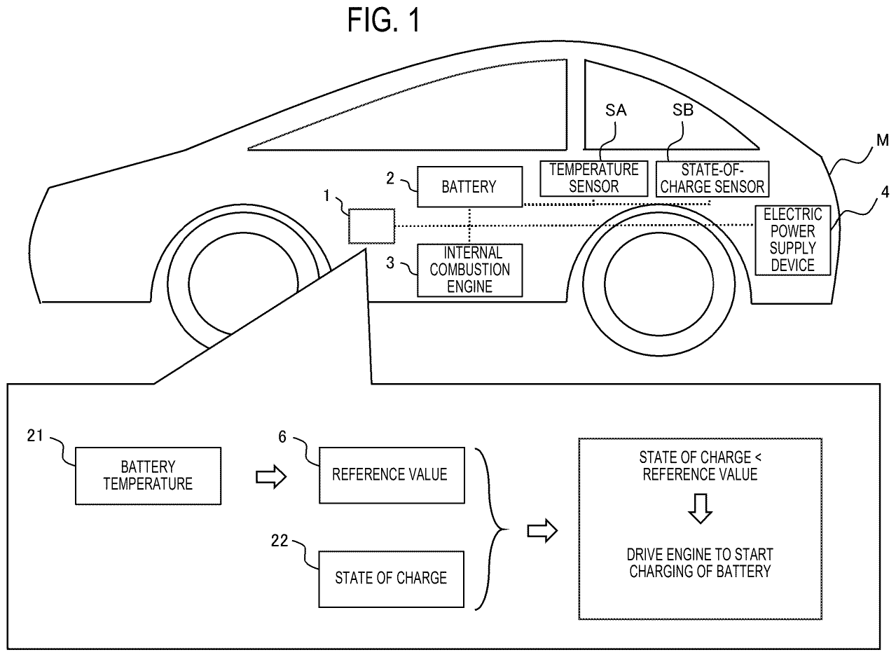

FIG. 1 schematically shows an example of a scene to which the present disclosure is applied. The information processing device 1 according to the present disclosure is mounted in a vehicle M including a battery 2 and an internal combustion engine 3. The information processing device 1 includes a controller 11 configured to execute, during electric power supply from the battery 2 to the outside:
acquiring a current battery temperature 21 of the vehicle M from a sensor SA;
determining a reference value 6 of a state of charge 22 for starting charging of the battery 2 by driving the internal combustion engine 3 in accordance with the acquired current battery temperature 21;
acquiring a current state of charge 22 of the vehicle M;
determining whether to start charging of the battery 2 in accordance with the acquired current state of charge 22 being smaller than the determined reference value 6; and
starting charging of the battery 2 by driving the internal combustion engine 3 of the vehicle M when it is determined to start charging.

Determining the reference value 6 is configured by setting the reference value 6 to a higher value as the current battery temperature 21 is lower.

### Vehicle

The type of the vehicle M may be appropriately selected depending on the embodiment as long as the vehicle M includes the battery 2 and the internal combustion engine 3 and is configured to be capable of electric power supply. In one example, the type of the vehicle M may include a hybrid electric vehicle such as a hybrid electric vehicle (HEV) or a plugin hybrid electric vehicle (PHEV). The number of wheels and the size of the vehicle M may be optionally selected. The vehicle M may be selected from, for example, a two-wheeled vehicle, a three-wheeled vehicle, and a four-wheeled vehicle. When the vehicle M is an automobile, the size of the vehicle M may be selected from a large size, a medium size, a semi-medium size, a normal size, a large special size, a small special size, and the like. When the vehicle M is a two-wheeled vehicle, the size of the vehicle M may be selected from a large size, a normal size, and the like.

### Power Transmission System and Electric Power Supply System

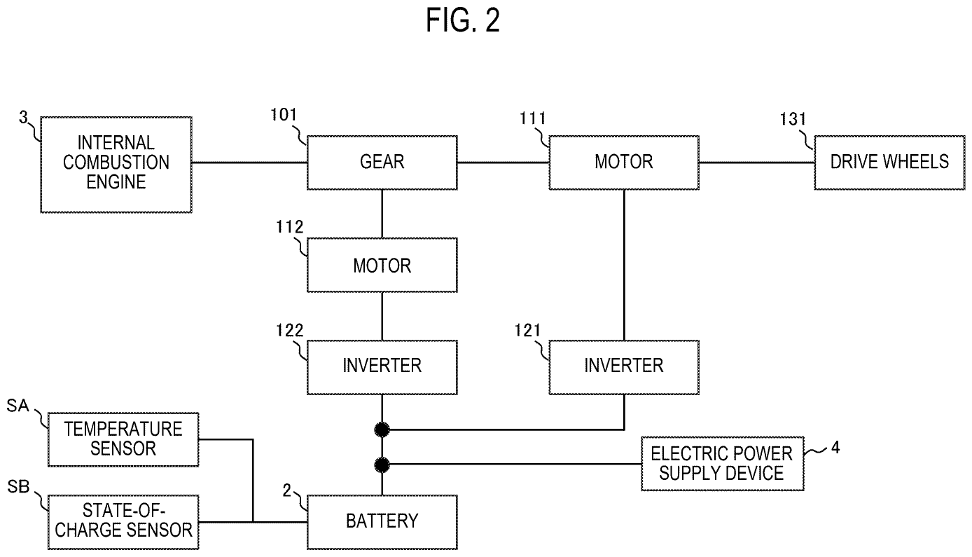

FIG. 2 schematically shows an example of a power transmission system and an electric power supply system of the vehicle M according to the present disclosure. The power transmission system may include the battery 2, the internal combustion engine 3, a gear 101, a motor 111, an inverter 121, and drive wheels 131. When the vehicle M is driven by the battery 2, power is transmitted from the battery 2 to the drive wheels 131 through the inverter 121 and the motor 111. When the vehicle M is driven by the internal combustion engine 3, power is transmitted from the internal combustion engine 3 to the drive wheels 131 through the gear 101 and the motor 111. When the vehicle M is driven by the battery 2 and the internal combustion engine 3, power is transmitted to the drive wheels 131 from the two paths. The electric power supply system may include the battery 2, the internal combustion engine 3, an electric power supply device 4, the gear 101, a motor 112, and an inverter 122. During the electric power supply, the vehicle M discharges the electric power stored in the battery 2 from the electric power supply device 4. When the electric power supply is performed using the internal combustion engine 3, the energy generated by the internal combustion engine 3 is converted into electric power by the gear 101. The generated electric power is discharged from the electric power supply device 4 through the motor 112 and the inverter 122. The generated electric power may be stored in the battery 2. In addition, the battery 2 is connected to the temperature sensor SA and a state-of-charge sensor SB. The configuration of the power transmission system and the electric power supply system may not be limited to the example of FIG. 2, and appropriate addition, deletion, substitution, and the like of the components may be performed.

### Measurement of Battery Temperature and State of Charge

The battery temperature 21 and the state of charge 22 may be measured by a known sensor. The type of the sensor that measures the battery temperature 21 and the state of charge 22 may not be particularly limited, and may be appropriately selected depending on the embodiment. The battery temperature 21 may be measured by the temperature sensor SA. The state of charge 22 may be measured by the state-of-charge sensor SB. The state of charge 22 may not be measured by the sensor. In this case, the state of charge 22 may be measured by a known method.

### Electric Power Supply to Outside

The electric power supply from the vehicle M to the outside is performed according to an electric power supply mode. The electric power supply mode includes an EV electric power supply mode and an HV electric power supply mode. The EV electric power supply mode is a mode in which the electric power supply is performed using solely the battery 2. The HV electric power supply mode is a mode in which the electric power supply is performed by combining the battery 2 and the internal combustion engine 3. The electric power supply by the HV electric power supply mode is usually performed using solely the battery 2 as in the EV electric power supply mode, but when the state of charge 22 is reduced, when the electric power supply performance deteriorates, and the like, the electric power generated by driving the internal combustion engine 3 is also used for the electric power supply. Hereinafter, in the present embodiment, a case in which the electric power supply is performed in the HV electric power supply mode will be assumed. A scene in which the electric power supply from the vehicle M to the outside may not be particularly limited. In addition, a setting of an output or the like needed for the electric power supply may not be particularly limited, and may be appropriately defined depending on the embodiment.

### Charging by Driving Internal Combustion Engine

The information processing device 1 may start the charging of the battery 2 by driving the internal combustion engine 3 in accordance with the current state of charge 22 being smaller than the reference value 6. When the state of charge 22 is equal to the reference value 6, the charging may be started or may not be started. A method of determining the reference value 6 may be appropriately defined depending on the embodiment. In one example, the information processing device 1 may determine the reference value 6 in accordance with the acquired current battery temperature 21. Determining the reference value 6 is configured by setting the reference value 6 to a higher value as the current battery temperature 21 is lower. The reference value 6 may be optionally set as long as the reference value 6 is equal to or larger than an electric-power-supply stop state-of-charge 7 described below.

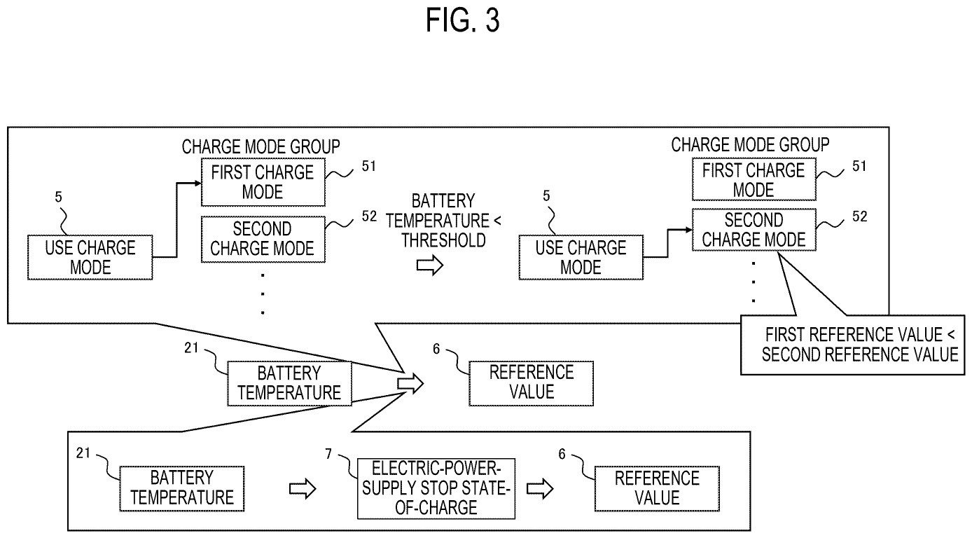

FIG. 3 schematically shows an example of a scene in which the reference value 6 is determined from the battery temperature 21. In one example, the determining the reference value 6 may be configured by selecting a use charge mode 5 from a plurality of charge modes in accordance with the acquired current battery temperature 21 and determining the reference value 6 in accordance with a definition of the selected use charge mode 5. The charge mode is a setting that defines an aspect of the charging, and includes a reference value (charging reference value) for starting the charging of the battery 2 by the internal combustion engine 3. An item defined in the charge mode may not be particularly limited as long as the item includes the charging reference value, and may be appropriately determined depending on the embodiment. In addition, a plurality of charge modes that is candidates for the use charge mode 5 may be defined in advance.

A method of selecting the use charge mode 5 from the plurality of charge modes may be appropriately determined depending on the embodiment. In one example, the use charge mode 5 may be selected in accordance with the current battery temperature 21. For example, the use charge mode 5 may be defined such that, when the current battery temperature 21 is smaller than a threshold, a charge mode in which a higher charging reference value is set is selected. The threshold may not be particularly limited, and may be appropriately determined depending on the embodiment.

In one example, the plurality of charge modes that is candidates for the use charge mode 5 may include a first charge mode 51 that defines a first reference value 61 as the charging reference value and a second charge mode 52 that defines a second reference value 62 as the charging reference value. The second reference value 62 may be set higher than the first reference value 61. In this example, the selecting the use charge mode 5 includes the following: switching (changing) the use charge mode 5 from the first charge mode 51 to the second charge mode 52 when the first charge mode 51 is selected as the use charge mode 5 and the acquired current battery temperature 21 is smaller than the threshold. That is, the selecting the use charge mode 5 includes selecting the second charge mode 52 as the use charge mode 5 when the acquired current battery temperature 21 is smaller than the threshold.

The second reference value 62 defined in the second charge mode 52 may be set to be equal to or larger than a state of charge 22 (hereinafter, electric-power-supply stop state-of-charge 7) at which the electric power supply by the battery 2 is stopped at a temperature equal to or lower than the threshold. The electric-power-supply stop state-of-charge 7 for each temperature may not be particularly limited, and may be appropriately defined depending on the embodiment. For example, the electric-power-supply stop state-of-charge 7 may be defined in advance for each temperature based on past data (actual measurement value) in which the electric power supply from the vehicle M to the outside is stopped. In addition, the electric-power-supply stop state-of-charge 7 may be defined based on data in which the electric power supply from another vehicle having a battery of the same type as the battery 2 to the outside is stopped.

In addition, the information processing device 1 may estimate the electric-power-supply stop state-of-charge 7. The estimation may include estimating the current electric-power-supply stop state-of-charge 7 and predicting the future electric-power-supply stop state-of-charge 7. A method of estimating the electric-power-supply stop state-of-charge 7 may not be particularly limited, and may be appropriately determined depending on the embodiment. In one example, the information processing device 1 may estimate the electric-power-supply stop state-of-charge 7 in accordance with the current battery temperature 21. For example, an estimation model may be used to estimate the electric-power-supply stop state-of-charge 7. The estimation model may be configured by at least any of a rule-based model or a trained machine learning model (trained model).

The rule-based model is configured to derive an inference result (electric-power-supply stop state-of-charge 7) from a given input in accordance with a rule. The rule may be appropriately set.

The machine learning model is configured to include one or more operation parameters that can be adjusted by machine learning. The one or more operation parameters are used for operation of the inference (estimation of the electric-power-supply stop state-of-charge 7) to be achieved. The machine learning model may be configured by, for example, a neural network, a support vector machine, or another functional expression (operation model). A method of machine learning may be appropriately selected depending on the machine learning model to be adopted (for example, an error backpropagation method). In one example, the machine learning model that estimates the electric-power-supply stop state-of-charge 7 may be a trained machine learning model that has acquired an ability to estimate the electric-power-supply stop state-of-charge 7 from the current battery temperature 21.

The battery temperature 21 used to estimate the electric-power-supply stop state-of-charge 7 may be time-series data. For example, when the estimation model is the machine learning model, since the battery temperature 21 is the time-series data, the estimation model can take in more information on the transition of the battery temperature 21 during training. As a result, the estimation model can improve the prediction precision of the electric-power-supply stop state-of-charge 7 at a future point in time.

### Determination of Whether Electric Power Supply Can Be Continued

During the electric power supply, the information processing device 1 may continuously calculate (estimate) the electric-power-supply stop state-of-charge 7. The information processing device 1 may determine whether the electric power supply can be maintained with the current reference value 6 by comparing the acquired new electric-power-supply stop state-of-charge 7 with the current reference value 6. When the electric-power-supply stop state-of-charge 7 is larger than the reference value 6, the information processing device 1 may determine that the electric power supply cannot be maintained. When the electric-power-supply stop state-of-charge 7 is smaller than the reference value 6, the information processing device 1 may determine that the electric power supply can be maintained. When the electric-power-supply stop state-of-charge 7 is equal to the reference value 6, the information processing device 1 may determine either whether the electric power supply can be maintained or whether the electric power supply cannot be maintained.

### Change of Reference Value

In response to the determination that the electric power supply cannot be maintained with the current reference value 6, the information processing device 1 may redetermine the reference value 6. That is, the information processing device 1 may change the current reference value 6. The new reference value 6 after the change may be appropriately determined to be the value equal to or larger than the electric-power-supply stop state-of-charge 7. In one example, when the reference value 6 is set by selecting the use charge mode 5, the information processing device 1 selects, from the plurality of charge modes, a charge mode that defines the charging reference value equal to or larger than the electric-power-supply stop state-of-charge 7 as a new use charge mode 5. As a result, the reference value 6 may be changed. A method of determining the charge mode to be selected when there is a plurality of candidates for the new use charge mode 5 may be appropriately defined. For example, among the candidates for the plurality of charge modes (charge mode group in which the charging reference value equal to or larger than the electric-power-supply stop state-of-charge 7 is set), a charge mode in which the smallest reference value is set may be selected as the new use charge mode 5.

Even when the electric-power-supply stop state-of-charge 7 calculated (estimated) during the electric power supply is smaller than the reference value 6, and it is determined that the electric power supply can be maintained with the current reference value 6, the information processing device 1 may change the current reference value 6. For example, when the charging of the battery 2 by driving the internal combustion engine 3 is performed early even though there is a large difference between the electric-power-supply stop state-of-charge 7 and the reference value 6 and there is a margin, the frequency of the charging increases, and the consumption of the fuel may increase. Therefore, in order to avoid such a situation, when the electric power supply can be maintained and the difference between the electric-power-supply stop state-of-charge 7 and while the reference value 6 is large, the information processing device 1 may change the reference value 6. A threshold for determining whether the difference between the electric-power-supply stop state-of-charge 7 and the reference value 6 is large may be appropriately determined.

In one example, a charge mode in which the reference value smaller than the reference value 6 set in the current use charge mode 5 and equal to or larger than the electric-power-supply stop state-of-charge 7 is set may be selected as the new use charge mode 5. The new use charge mode 5 is a charge mode when the electric power supply can be maintained and while the difference between the electric-power-supply stop state-of-charge 7 and the reference value 6 is large. A method of determining the use charge mode 5 to be selected when there is a plurality of candidates for the new use charge mode 5 may be appropriately defined. For example, among the candidates for the plurality of use charge modes 5, a charge mode in which the largest reference value is set may be selected as the new use charge mode 5.

A method of determining the reference value 6 may not be limited to the method of selecting the use charge mode 5 from the plurality of charge modes, and may be appropriately defined depending on the embodiment. In another example, the information processing device 1 may set the reference value 6 to any value equal to or larger than the estimated electric-power-supply stop state-of-charge 7. That is, the determining the reference value 6 may be configured by estimating the electric-power-supply stop state-of-charge 7 in accordance with the acquired current battery temperature 21 and setting the reference value 6 to a value equal to or larger than the estimated electric-power-supply stop state-of-charge 7. As described above, the information processing device 1 may dynamically set the reference value 6 in accordance with the estimation result of the electric-power-supply stop state-of-charge 7.

As described above, by estimating the electric-power-supply stop state-of-charge 7 and setting the reference value 6 to a value equal to or larger than the estimated electric-power-supply stop state-of-charge 7, it is possible to increase the possibility that the electric power supply can be maintained even when the battery temperature 21 is in a low-temperature state. It is also expected that when the internal combustion engine 3 is driven while the battery temperature 21 is in a low-temperature state, the battery 2 is heated, and thus the electric power supply performance is improved.

### 2 Configuration Example

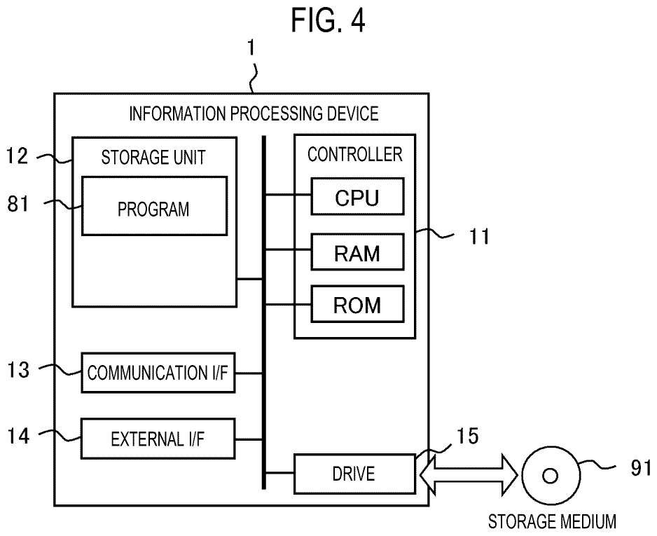

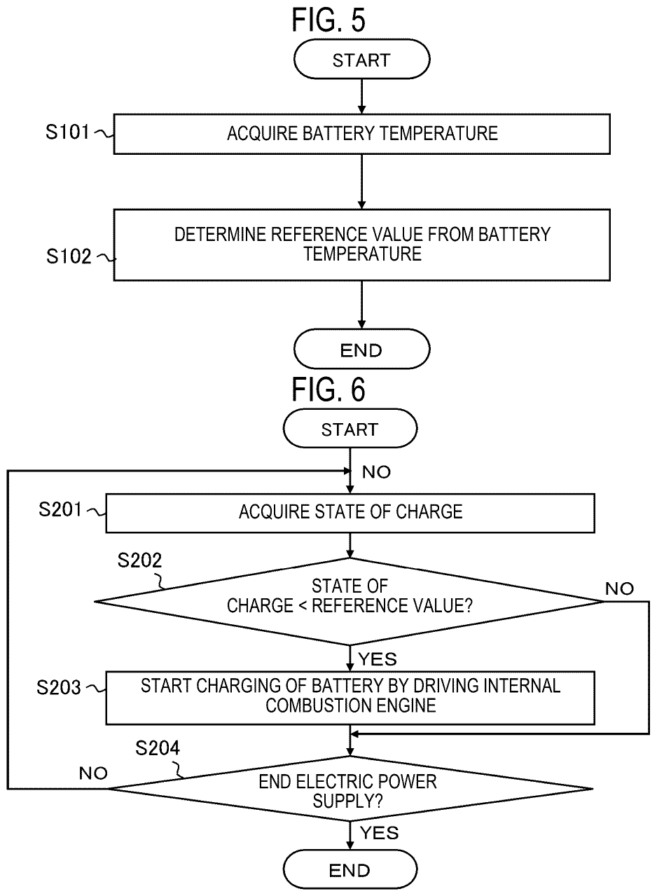

FIG. 4 schematically shows an example of a hardware configuration of the information processing device 1 according to the present disclosure. As shown in FIG. 5, the information processing device 1 according to the present embodiment is a computer in which a controller 11, a storage unit 12, a communication interface 13, an external interface 14, and a drive 15 are electrically connected to each other. The controller 11 includes a central processing unit (CPU), a random access memory (RAM), a read only memory (ROM), and the like, and is configured to execute any information processing. The storage unit 12 may be configured by, for example, a hard disk drive or a solid state drive. In the present embodiment, the storage unit 12 stores a program 81. The program 81 is a program for causing the information processing device 1 to execute the information processing according to the present embodiment. The program 81 includes a series of commands of the information processing.

The communication interface 13 is configured to perform wired or wireless data communication via a network. The communication interface 13 may be configured by, for example, a wired local area network (LAN) module and a wireless LAN module. In the present embodiment, the information processing device 1 may execute data communication with another computer (for example, an electronic control unit (ECU) and an external server) via the network by using the communication interface 13. The external interface 14 may be, for example, a universal serial bus (USB) port, a dedicated port, and a wireless communication port, and is configured to be connected to an external device in a wired or wireless manner. In the present embodiment, the information processing device 1 may be connected to the sensor SA and the sensor SB via the external interface 14.

The drive 15 is a device for reading various types of information, such as the program, stored in a storage medium 91. The program 81 may be stored in the storage medium 91 instead of the storage unit 12 or together with the storage unit 12. The storage medium 91 is configured to store various types of information by an electric, magnetic, optical, mechanical, or chemical action such that a machine such as the computer can read the information (the stored program or the like). The information processing device 1 may acquire the program 81 from the storage medium 91. The storage medium 91 may be a disk-type storage medium such as a CD or a DVD, or may be a storage medium other than the disk type, such as a semiconductor memory (for example, a flash memory). The type of the drive 15 may be appropriately selected depending on the type of the storage medium 91.

Regarding the specific hardware configuration of the information processing device 1, components can be omitted, replaced, or added as appropriate depending on the embodiment. For example, the controller 11 may include a plurality of hardware processors. The hardware processor may be configured by a microprocessor, a field-programmable gate array (FPGA), a digital signal processor (DSP), a graphics processing unit (GPU), an application specific integrated circuit (ASIC), and the like.

### 3 Operation Example

FIG. 5 shows an example of a processing procedure of the information processing device 1 according to the present disclosure for determining the reference value 6 of the state of charge 22 for starting the charging of the battery 2 from the battery temperature 21.

In S101, the controller 11 acquires the battery temperature 21 from the sensor SA. When the battery temperature 21 is acquired, the controller 11 advances processing to S102. In S102, the controller 11 determines the reference value 6 from the acquired battery temperature 21. In this case, the reference value 6 may be determined to be a higher value as the battery temperature 21 is lower. A method of determining the reference value 6 based on the battery temperature 21 may not be particularly limited, and may be appropriately defined. In one example, the determining the reference value 6 may be configured by selecting a use charge mode 5 from a plurality of charge modes in accordance with the acquired current battery temperature 21 and determining the reference value 6 in accordance with a definition of the selected use charge mode 5. In another example, the determining the reference value 6 may be configured by estimating the electric-power-supply stop state-of-charge 7 in accordance with the acquired current battery temperature 21 and setting the reference value 6 to a value equal to or larger than the estimated electric-power-supply stop state-of-charge 7. When the reference value 6 is determined, the controller 11 ends the present processing procedure.

The processing procedure of determining the reference value 6 may be performed before the electric power supply is started. By appropriately performing the processing procedure during the electric power supply, the information processing device 1 may change (update) the reference value 6 at any time. The electric power supply from the vehicle M to the outside is started by the HV electric power supply mode based on the reference value 6 determined above.

FIG. 6 shows an example of a processing procedure of the information processing device 1 according to the present disclosure during the electric power supply from the vehicle M to the outside.

### S201 and S202

In S201, the controller 11 acquires the state of charge 22. The state of charge 22 may be acquired from the state-of-charge sensor SB. In S202, the controller 11 determines whether the acquired state of charge 22 is smaller than the reference value 6. When the state of charge 22 is equal to or larger than the reference value 6, the controller 11 proceeds to S204. When the state of charge 22 is smaller than the reference value 6, the controller 11 advances processing to the next S203.

### S203 and S204

In S203, the controller 11 starts the charging of the battery 2 by driving the internal combustion engine 3. In S204, it is determined whether to continue the electric power supply from the battery 2 to the outside. When the electric power supply is continued, the controller 11 returns the processing to S201 and repeats the processing from S201. When the electric power supply is ended, the controller 11 ends the present processing procedure.

The processing procedure of the information processing device 1 may not be limited to the examples of FIGS. 5 and 6, and may be appropriately changed depending on the embodiment.

### Features

In the present embodiment, the information processing device 1 determines the reference value 6 corresponding to the acquired battery temperature 21 by the processing of S102. For example, the reference value 6 is set to a higher value as the battery temperature 21 is lower. As a result, the electric power supply performance can be ensured by driving the internal combustion engine 3 to charge the battery 2 before the electric power supply performance deteriorates and the electric power supply is stopped. As a result, according to the present embodiment, the electric power supply performance can be ensured and the electric power supply can be continued even when the battery temperature 21 is in a low-temperature state.

### 4 Modification

Although the embodiment of the present disclosure has been described in detail above, the description so far is merely an example of the present disclosure in every respect. It is needless to say that various improvements or modifications can be made without departing from the scope of the present disclosure. The processing and means described in the present disclosure can be freely combined and implemented as long as a technical contradiction does not occur.

What is claimed is:

1. An information processing device mounted in a vehicle including a battery and an internal combustion engine, the information processing device comprising a controller configured to execute, during electric power supply from the battery to an outside:
acquiring a current battery temperature of the vehicle from a sensor;
determining, in accordance with the acquired current battery temperature, a reference value of a state of charge at which charging of the battery by driving the internal combustion engine is started;
acquiring a current state of charge of the vehicle;
determining whether to start the charging of the battery in accordance with the acquired current state of charge being lower than the determined reference value; and
starting the charging of the battery by driving the internal combustion engine of the vehicle when determination is made to start the charging,
wherein the determining the reference value includes setting the reference value to a higher value as the current battery temperature is lower.

2. The information processing device according to claim 1, wherein:
the determining the reference value includes
selecting a use charge mode from a plurality of charge modes in accordance with the acquired current battery temperature, and
determining the reference value in accordance with a definition of the selected use charge mode;
the charge modes include a first charge mode defining a first reference value as the reference value, and a second charge mode defining a second reference value as the reference value;
the second reference value is set higher than the first reference value; and
the selecting the use charge mode includes switching the use charge mode from the first charge mode to the second charge mode when the first charge mode is selected as the use charge mode and the acquired current battery temperature is lower than a threshold.

3. The information processing device according to claim 2, wherein the second reference value is set to be equal to or higher than a state of charge at which the electric power supply from the battery is stopped when the battery temperature is equal to or lower than the threshold.

4. The information processing device according to claim 1, wherein the determining the reference value includes
estimating, in accordance with the acquired current battery temperature, a state of charge at which the electric power supply from the battery is stopped, and
setting the reference value to a value equal to or higher than the estimated state of charge at which the electric power supply is stopped.

5. A non-transitory storage medium storing a program for causing a computer to execute an information processing method comprising, during electric power supply from a battery of a vehicle to an outside, the vehicle including the battery and an internal combustion engine:
acquiring a current battery temperature of the vehicle from a sensor;
determining, in accordance with the acquired current battery temperature, a reference value of a state of charge at which charging of the battery by driving of the internal combustion engine is started;
acquiring a current state of charge of the vehicle;
determining whether to start the charging of the battery in accordance with the acquired current state of charge being lower than the determined reference value; and
starting the charging of the battery by driving the internal combustion engine of the vehicle when determination is made to start the charging,
wherein the determining the reference value is configured by setting the reference value to a higher value as the current battery temperature is lower.
